(19) United States
(12) Patent Application Publication
(10) Pub. No.: US 2011/0097039 A1
(43) Pub. Date: Apr. 28, 2011

(54) Optoelectronic interconnection system

(75) Inventors: Jim Zhao, Irvine, CA (US); Andrew C. Cheng, Diamond Bar, CA (US)

(73) Assignee: HON HAI PRECISION IND. CO., LTD.

(21) Appl. No.: 12/589,782

(22) Filed: Oct. 28, 2009

(51) Int. Cl. G02B 6/38

(52) U.S. Cl. 385/70; 385/75

(57) ABSTRACT

Disclosed herewith a interconnection system includes an optoelectronic receptacle connector including insulative housing defines a cylindrical receiving chamber having a front and a rear end. An aligning pin extends from the rear end into the chamber and with an optical receiver disposed in the chamber. An optoelectronic plug connector includes a jack member defining a passage to receive the aligning pin when the plug connector is inserted into the receptacle connector. An organizer is enveloped on the jack member and defines at least a pair of orifices aligned with the optical receiver. And an optoelectronic cable includes at least a pair of fiber optics disposed within the orifices of the organizer and at least a conductive wires terminated to the jack member.

### FIELD OF THE INVENTION

The present invention relates to an interconnection system, and more particularly to an optoelectronic interconnection system in which power supply is provided to support peripheral devices.

### DESCRIPTION OF PRIOR ART

U.S. Pat. No. 5,879,173 issued to Poplawski et al. on Mar. 9, 1999 discloses an optoelectronic device. According to its disclosure, a robust optoelectronic transceiver module which is quick, easy, and inexpensive to manufacture is provided. The transceiver module has a main housing which consists of a potting box with potting material inserted therein. In addition, a circuit board is encased by the potting material. The circuit board has an optical subassembly mounted thereon. The optical subassembly extends outside of the potting box through a recess. Correspondingly, a recess cover is provided for forming a liquid tight seal between the recess cover, the potting box, and the optical subassembly. The module housing may be pluggable via release levers having detentes received in apertures of a receptacle and a pluggable connector of the module mated within the receptacle. The receptacle may include grounding means such as a ground clip mounted within the receptacle and a protective door to limit electromagnetic emissions.

U.S. Pat. No. 6,071,017 issued to Gilliland et al on Jun. 6, 2000 discloses another technology in which an optical package is provided including a housing having first and second ends. A ferrule receiving bore is formed in the first end, and an optics cavity is formed in the second end. The optics cavity and the ferrule receiving bore are axially aligned with one another along an optical axis defined by the package. A mounting cap is inserted over the optics cavity and frictionally engages an outer surface of the housing. The end cap includes an endplate and a substrate having an optical device mounted thereon.

U.S. Pat. No. 5,528,408 issued to McGinley on Jun. 18, 1996 discloses n optoelectronic transceiver having a small footprint and including a laser diode package contained within a subassembly mounted within a housing of the transceiver. The housing includes latches for retaining subassemblies therein. Subassemblies include first apertures for receiving mounting pins to lock the subassemblies within the housing. Plug latch members are mounted onto the subassemblies. Optical transmitter and receiver circuits and one row of nine contacts are mounted to a printed circuit board mounted within the housing of the transceiver.

U.S. Pat. No. 6,659,654 issued to Kao on Dec. 3, 2003 discloses another type of optical connector in which a fiber array includes a plurality of ferrules, a plurality of optical fibers, a press plate, a holder plate, and a housing. Each ferrule defines a channel for retaining the corresponding optical fiber and an annular groove for engagingly receiving a ring. The press plate defines a plurality of first through holes, and a plurality of posts corresponding to the first through holes movably turn therein to abut against the ferrule. The holder plate is secured together with the press plate and defines a plurality of second through holes corresponding to the first through holes of the press plate for receiving and holding corresponding said ferrules. A plurality of springs are interposed between the corresponding rings and the holder plate, and abut against the ring and the holder plate. Each ferrule can be slightly adjusted for exactly receiving transmitting light from a corresponding lens array by turning the post with an adjusting tool and a wrench.

One of the problems which an optical connector encounters is alignment between two optical fibers. Typically, a ferrule is introduced to ensure a substantially true position between the optical fibers is ensured, while this inevitably increase cost and manufacturing processes.

One of the current developments is using the existing USB 2.0 form factor in which two pair of fiber optics are incorporated, while a pair of contact terminals are used to serve as power supply.

U.S. Pat. No. 7,572,071 issued to Wu on Aug. 11, 2009 discloses a cable assembly (1) that includes an insulative housing (2) having a base portion (21) and a tongue portion (22). The tongue portion (22) defines a number of cavities (222) recessed inwardly from one of an upper or a bottom surfaces of the tongue portion; and a number of lenses (5) is retained in the cavities (222) and connected to corresponding optical fiber (103). A plurality of contacts (3, 4) is mounted to the insulated housing (2), and each of the contacts has a mating portion (32, 42) disposed about the other surface of the tongue portion (22) and a tail portion (36, 46) rearward extending beyond the base portion (21) for electrically connecting with a corresponding wire.

WO Publication No. WO2008121731 invented by Chen and published on Sep. 10, 2008 discloses embodiments of an optical USB (OUSB) to enhance the data rate of USB by adding super-high data rate (e.g. 10 Gbps) optical communication on top of its current specification so that backward compatibility is achievable. Mechanical tolerances may be achieved by using embedded lenses to expand a beam emerging from the connector prior to entering its mating connector and using an identical lens in the mating connector to collimate the beam back onto a fiber.

### SUMMARY OF THE INVENTION

An object of the current invention is to provide a novel interface in which fiber optics are arranged concentrically while can be properly aligned readily and conveniently.

Yet another object of the current invention is to provide a novel interface in which a central pin and an outer pin are used to transmit power.

Yet another object of the current invention is to provide an novel interface in which both the central pin and the outer pin provide alignment and guidance.

In order to achieve the object set forth, an optoelectronic cable assembly made in accordance with the present invention includes a first conductive member with a fiber optic organizer slidably enveloped over the first conductive member and including at least a pair of orifices extending therethrough. A second conductive member is enveloped over the fiber optic organizer. A pair of fiber optics is disposed within the orifices; and a pair of conductive wires is terminated and interconnected to the first and second conductive member, respectively.

According to one aspect of the invention, a lens array is disposed in front of the organizer having a plurality of lens each aligned with a corresponding fiber optic.

Still according to another aspect of the invention, the first and second conductive wires are arranged concentrically.

Still according to another aspect of the invention, a coil spring is disposed between the second conductive member and the organizer driving the organizer forwardly.

According to one aspect of the present invention, a interconnection system is provided and includes an optoelectronic receptacle connector including insulative housing defines a cylindrical receiving chamber having a front and a rear end. An aligning pin extends from the rear end into the chamber and with an optical receiver disposed in the chamber. An optoelectronic plug connector includes a jack member defining a passage to receive the aligning pin when the plug connector is inserted into the receptacle connector. An organizer is enveloped on the jack member and defines at least a pair of orifices aligned with the optical receiver. And an optoelectronic cable includes at least a pair of fiber optics disposed within the orifices of the organizer and at least a conductive wires terminated to the jack member.

According to one aspect of the system, a first lens array is disposed in front of the organizer; and a second lens array is disposed in front of the optical receiver.

### BRIEF DESCRIPTION OF DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is an exploded and perspective view of an optoelectronic plug connector made in accordance with the present invention;

FIG. 2 is an assembled perspective view of an optoelectronic plug connector and an optoelectronic receptacle connector made in accordance with the present invention;

FIG. 3 is similar to FIG. 2 but with the plug and receptacle interconnected;

FIGS. 4A, 4B, and 4C are side elevational views showing a mating process between the plug and receptacle connectors; and

FIG. 5 is a perspective view showing an alternative of an optoelectronic cable made in accordance with the present invention.

### DETAILED DESCRIPTION OF PREFERRED EMBODIMENT

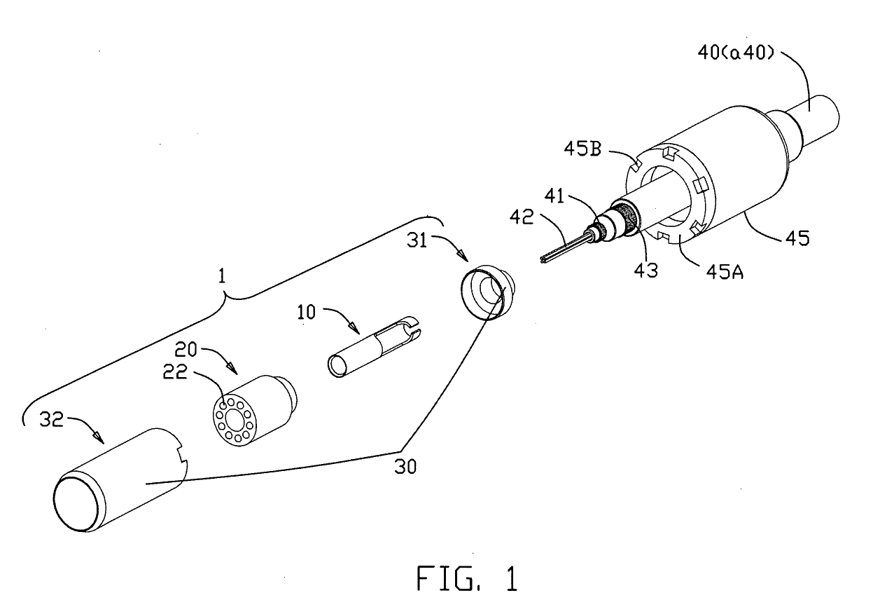

Referring to FIG. 1, an optoelectronic plug connector 1 made in accordance with the present invention includes a first conductive member 10, which is a cylindrical conductive member. A fiber optic organizer 20 is moveably enveloped over the first conductive member 10 and includes a plurality of orifices or passage 21 extending therethrough. According to the preferred embodiment, totally eight (8) orifices are provided such that eight (8) fiber optics can be installed thereby four (4) channels can be configured. Each of the orifices 21 is further provided with a lens 22 which can be integrally formed with the organizer 20 or the lens 22 can be configured into a ring and then secured to the front of the organizer 20. A second conductive member 30 is enveloped over the fiber optic organizer 20.

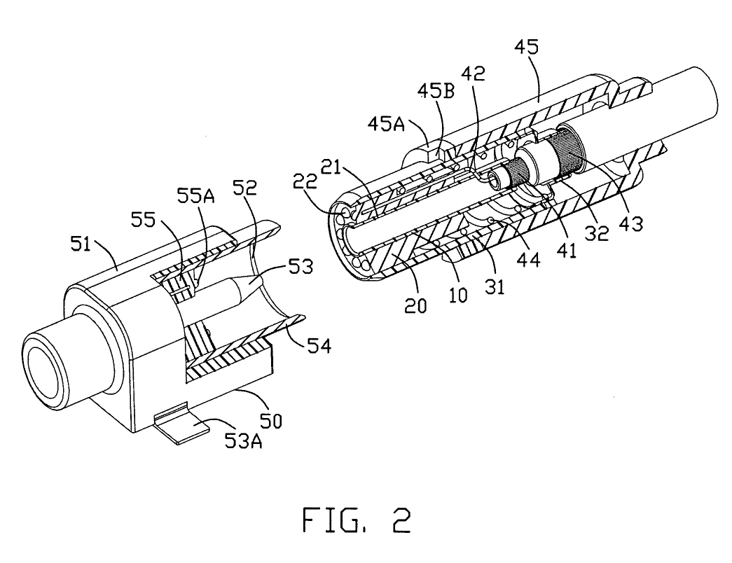

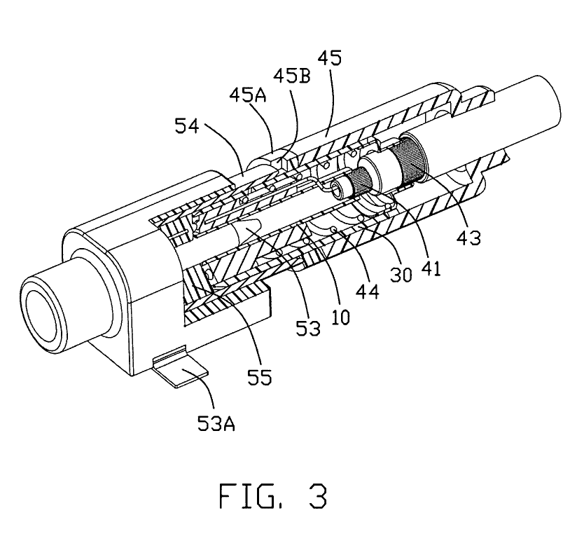

In this embodiment, both the first and second conductive members 10 and 30 are configured with a circular or cylindrical configuration which is essentially in the alignment of the lens 22 in aligning with a complementary optic connector 50, as shown in FIG. 2. As it is well established in the field that alignment can be preferably and readily achieved by means of dowel post, and this is why the alignment devices used in the connector are cylinder. U.S. Pat. No. 5,173,063 issued to Barkus on Dec. 22, 1992 discloses an example. Since both the first and second conductive members 10 and 30 can be used as an aligning reference, the lens 22 of the organizer 20 can be readily aligned as compared to those prior art devices which have different form factor, such as a USB form factors.

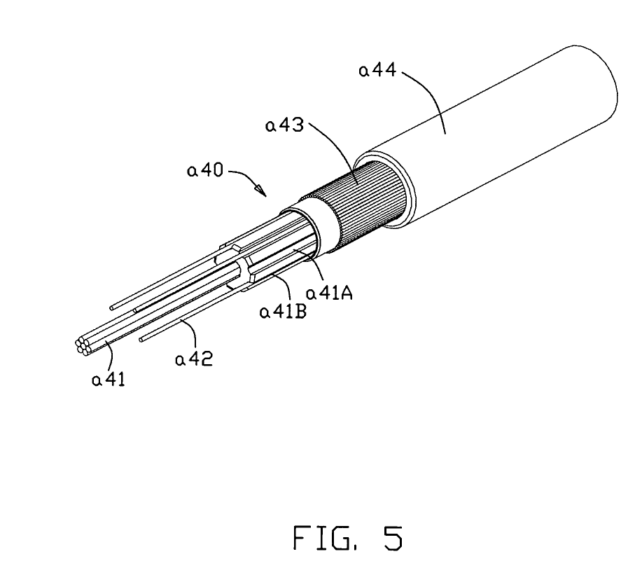

An optoelectronic cable a40 can be used with the plug connector 1, please referring to FIG. 5. The optoelectronic cable a40 includes a first conductive wire a41 as a central element, and then insulated and coved with a plurality of fiber optics a42. When stranded conductive wires a41 are used as central element, the first conductive member 10, which can be embodied as a tube, can directly cramped onto the stranded conductive wires a41. Then the fiber optics a42 are deployed over the insulated conductive wires a41 by means of an insulative carrier a41A. The carrier a41A is made from insulative material, and defined with open grooves a41B around its circumference such that the fiber optics a42 can run therethrough. In addition, each of the fiber optic a42 is accompanied with a strain relief, such as a Kevlar wire. In this embodiment, totally eight (8) fiber optics are included. Of course, alternative numbers of fiber optics can also be used, for example, from two (2) to eight (8) pairs of fiber optics can be used. Then a second conductive layer a43 is deployed over the fiber optics a42. The scenario of using the first and second conductive wires a41 and a43 are it can be used as power lines, i.e. the first conductive wire a41 is hot line, and the second conductive wire a43 is a ground line. An outer jacket a44 is deployed over the second conductive wire a43.

On the other hand, as shown in FIG. 1, the embodiment shown that the fiber optics 42 can be disposed in the center, while the first and second conductive wires 41 and 43 are concentrically deployed over the fiber optics 42. An overmold 45 can be further deployed to enclose both the first and second conductive members 10, 30 along with the interconnections between the conductive wires 41/43 and the first and second conducive members 10/30. An anti-disorientation ring 45A having notches 45B can be also disposed in front of the overmold 45.

Now referring to FIG. 2, the optoelectronic plug connector 1 is optoelectronically interconnected with the optoelectronic cable 40. The interconnection between the first conductive member 10 and the first conductive wire 41 can be used with solder. Alternatively, cramping is an alternative, such as the cable shown in FIG. 5. The fiber optics 42 can be properly inserted into the orifices 21 of the organizer 20, and then proper adhesive can be deployed to securely position the fiber optic 42 within the orifices 21 of the organizer 20.

The second conductive member 30 configured with a first part 31 and a second part 32, which is a cap 32. The cap 32 is first soldered onto the second conductive wire 43, and then the first part 31, also a cylindrical tube 31 is securely attached to the cap 32, by soldering or any equivalent. In this embodiment, a coil spring 44 is disposed in the cap 32 driving the organizer 20 forward. As the organizer 20 is slidably assembled onto the first conductive member 10, this coil spring 44 is very essential to provide a driving thrust such that the organizer 20 will always in its preferred position in interconnecting electrically and optically with a complementary connector 50.

Referring to FIG. 2, the optoelectronic receptacle connector 50 made in accordance with the present invention is optoelectrically interconnected with the plug connector 1. The receptacle connector 50 includes an insulative housing 51 defining a receiving chamber 52. A core pin 53 is disposed in the chamber 52. The core pin 53 includes a cone 53a in which a passage 11 of the first conductive member 10 can be readily aligned and enveloped over the core pin 53, or the core pin 53 can be accurately and snugly inserted into the passage 11 of the first conductive member 10. As stated above, the dimension of both the core pin 53 and the passage 11 of the first conductive member 10 can be readily machined and controlled such that the alignment of the lens 22 can be readily achieved. If the receptacle connector 50 is to be mounted onto a printed circuit board by means of surface mount, then a solder pad 53A for the core pin 53 can be facilitated or alternatively, a solder pin can be arranged.

The receptacle connector 50 further includes a tube 54 corresponding to the second conductive member 30. Again, both the tube 54 and the second conductive member 30 can be dimensioned snugly and corporate with the core pin 53 and the first conductive member 10 so ensure the alignment of the lens 22. Accordingly, as compared with the USB interface discussed above, the present invention provide an even better optical alignment. The tube 54 can also be provided with a solder pad or pin for mounting onto the printed circuit board.

The receptacle connector 50 further includes an optical receiver 55 corresponding to the organizer 20 of the plug connector 1. The receiver 55 is also provided with a lens 55a, which can be integrally formed or configured separately.

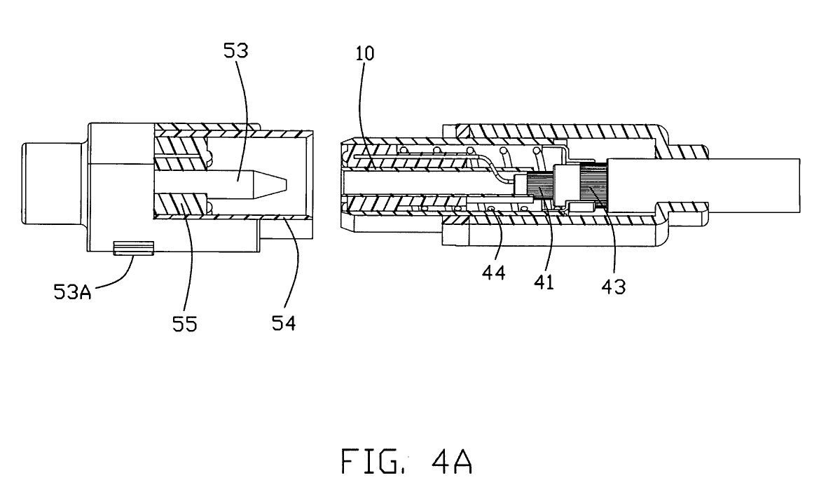

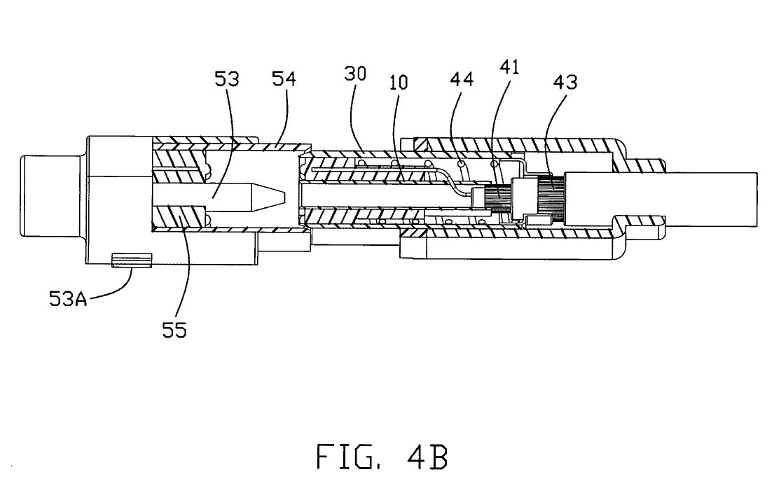

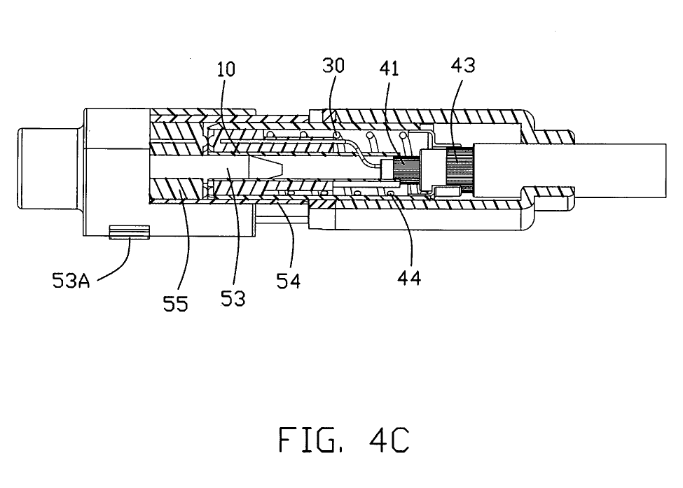

Referring to FIGS. 4A, 4B and 4C, interconnection between the plug connector 1 and the receptacle connector 50 is gradually mated with each other by the help and benefit of the alignment between the first conductive member 10 and the cone pin 53 and the second conductive member 30 and the tube 54. Specially, after the plug connector 1 is completely inserted into the receptacle connector 50, the length of the tube 54 is preset such that the lens 22 of the organizer 20 will not physically in contact with the lens 55a of the optical receiver 55 as both the lens 22 and the 55a are critical to the transmission of the light.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. An optoelectronic cable assembly, comprising:
a first conductive member;
a fiber optic organizer slidably enveloped over the first conductive member and including at least a pair of orifices extending therethrough;
a second conductive member enveloped over the fiber optic organizer;
a pair of fiber optics disposed within the orifices; and
a first and second conductive wires interconnected to the first and second conductive member, respectively.

2. The cable assembly as recited in claim 1, wherein a lens array is disposed in front of the organizer and has a plurality of lenses each aligned with a corresponding fiber optic.

3. The cable assembly as recited in claim 1, wherein the first and second conductive wires are arranged concentrically.

4. The cable assembly as recited in claim 1, wherein a coil spring is disposed between the second conductive member and the organizer.

5. An optoelectronic connector, comprising:
a first conductive member;
a fiber optic organizer enveloped over the first conductive member and including at least a pair of orifices extending therethrough;
a second conductive member enveloped over the fiber optic organizer.

6. The optoelectronic connector as recited in claim 5, wherein a lens ring is disposed in front of the organizer and has at least two lens each aligned with the orifice.

7. The optoelectronic connector as recited in claim 5, wherein the first conductive member has a central hole defined in a front wall thereof.

8. The optoelectronic connector as recited in claim 7, wherein the central hole is provided with a key.

9. The optoelectronic connector as recited in claim 7, wherein the fiber organizer is provided with at least one align pin.

10. The optoelectronic connector as recited in claim 5, wherein the first conductive member, the fiber optic organizer and the second conductor member are of a round tubular shape and concentrically arranged with one another in an outward sequence.

11. The optoelectronic connector as recited in claim 10, wherein the first conductive member provides a radially outward interface surface for electrical and mechanical engagement with a first complementary part, and the second conductive member provides a radially inward interface surface for electrical and mechanical engagement with a second complementary part, while the fiber optic organizer provides a axially forward interface surface for optical engagement with a third complementary part.

12. The optoelectronic connector as recited in claim 10, wherein the first conductive member provides a radially inward interface surface for electrical and mechanical engagement with a first complementary part, and the second conductive member provides a radially outward interface surface for electrical and mechanical engagement with a second complementary part, while the fiber optic organizer provides a axially forward interface surface for optical engagement with a third complementary part.

13. The optoelectronic connector as recited in claim 10, further including a first set of wires electrically and mechanically connected to the first conductive member, a second set of wires electrically and mechanically connected to the second conductive member, and a set of optic fibers respectively received in the corresponding orifices.

14. An optoelectronic interconnection system, comprising:
an optoelectronic receptacle connector including insulative housing defining a cylindrical receiving chamber having a front and a rear end, an aligning pin extending from the rear end into the chamber, the receptacle further including an optical receiver in the chamber;
an optoelectronic plug connector including a jack member defining a passage receiving the aligning pin when the plug connector is inserted into the receptacle connector;
an organizer enveloped on the jack member and defining at least a pair of orifices aligned with the optical receiver; and
an optoelectronic cable including at least a pair of fiber optics disposed within the orifices of the organizer and at least a conductive wires terminated to the jack member.

15. The interconnection system as recited in claim 14, wherein a first lens array is disposed in front of the organizer.

16. The interconnection system as recited in claim 14, wherein a second lens array is disposed in front of the optical receiver.

17. An optoelectronic cable, comprising:
a core conductive wire;
an insulative carrier enveloped over the core conductive wire, and defining at least a pair of open passage along its peripheral;
at least a pair of fiber optics disposed within the open passages;
a layer of second conductive wire disposed over the carrier.

18. The optoelectronic cable as recited in claim 17, wherein a strain relief is disposed within the passage.

19. The optoelectronic cable as recited in claim 18, an insulative layer is wrapped over the carrier.

20. The optoelectronic cable as recited in claim 18, the strain relief is made from Kevlar.
